(19) United States
(12) Patent Application Publication
(10) Pub. No.: US 2021/0120739 A1
(43) Pub. Date: Apr. 29, 2021

(54) Multiple Channels for Receiving Dispensed Fruit

(71) Applicant: Abundant Robotics, Inc., Hayward, CA (US)

(72) Inventors: Curt Salisbury, CA (US); Michael Stevens, Hayward, CA (US)

(21) Appl. No.: 16/973,850

(22) PCT Filed: Aug. 29, 2019
(86) PCT No.: PCT/US2019/048743

§ 371 Date: Dec. 10, 2020

Related U.S. Application Data
(60) Provisional application No. 62/726,069, filed on Aug. 31, 2018.

(51) Int. Cl. A01D 46/00; A01D 46/30; A01D 46/253; A01D 61/02

(52) U.S. Cl. CPC A01D 46/005; A01D 61/02; A01D 46/253; A01D 46/30

(57) ABSTRACT

A robotic system (100) for harvesting fruit (12) includes an end effector (102) with a conduit extending between an input port and an output port. A vacuum system (108) coupled to the end effector (102) provides suction to suck an object into the input port. A collection system (110) includes multiple channels that extend along a vertical axis and are positioned in series along a horizontal axis. A positioning system (104) moves the end effector (102) along the horizontal and/or vertical axes and extends the end effector (102) away from the collection system (110) to position the input port near an object (e.g., fruit). Responsive to the object being sucked into the conduit, the positioning system (104) moves the end effector (102) to position the output port at a selected channel of the multiple channels to allow the object to be dispensed into the selected channel The selected channel is closest to the end effector (102) along the horizontal axis.

### CROSS-REFERENCE TO RELATED APPLICATIONS

This application claims the benefit of, and priority to, U.S. Provisional Patent Application Ser. No. 62/726,069, filed Aug. 31, 2018, the contents of which are incorporated entirely herein by reference.

### BACKGROUND

Fruit plucking and harvesting remains a largely manual process. In a fruit orchard in which fruit such as apples, pears, apricots, peaches, etc., grows on trees, a farm laborer may move a ladder near a tree, climb the ladder, pluck the fruit, and transfer the fruit to a temporary storage like a basket. After the worker has plucked all the ripe fruit in that location, the worker climbs down and moves the ladder to another location, then repeats the process. This process has high labor requirements, which result in high costs of operation, thus lowering profits made by the farmers.

Relying on manual labor may also have other risks. For instance, illness or other unavailability of workers may affect the labor supply. As another example, the lack of untrained workers can lead to careless handling or mishandling of the fruit. While picking fruit seems to require workers of low skill and training, a skilled farm worker may pluck as many as two fruits per second with relatively low losses due to damage, whereas untrained workers may work significantly slower, and may cause much higher losses due to damaged fruit. The cost of training workers may contribute to significant cost increases in operating the farm.

Therefore, it may be desirable to have mechanized fruit harvesting systems that alleviate some of the risks associated with manual labor. An example mechanized system may have an end-effector configured to pluck a fruit rather than plucking the fruit manually.

### SUMMARY

The present disclosure describes embodiments that relate to systems for robotic harvesting.

According to an example implementation, a harvesting system includes an end effector including a conduit extending between an input port and an output port. The system includes a vacuum system coupled to the end effector and configured to provide the end effector with suction that allows an object (e.g., fruit) to be sucked through the input port and into the conduit. The suction further causes the object to move through the conduit toward the output port. The system includes a collection system including multiple channels extending along a vertical axis. The multiple channels are positioned in series along a horizontal axis. The system includes a positioning system coupled to the end effector and configured to move the end effector relative to the collection system. The positioning system is configured to move the end effector along the horizontal axis and/or the vertical axis and to extend the end effector away from the collection system and position the input port near the object to allow the suction from the vacuum system to suck the object through the input port and into the conduit. Responsive to the object being sucked into the conduit, the positioning system is further configured to move the end effector toward the collection system and to position the output port at a selected channel of the multiple channels to allow the object to be dispensed from the output port into the selected channel. The selected channel is closest to the end effector along the horizontal axis from among the multiple channels.

### BRIEF DESCRIPTION OF THE FIGURES

FIG. 1 illustrates a diagram of a robotic system for harvesting fruit, in accordance with an example implementation.

FIG. 2 illustrates a perspective view of a robotic system, including multiple channels for receiving harvested fruit, in accordance with an example implementation.

FIG. 3 provides another view of the multiple channels shown in FIG. 2.

FIG. 4 provides a sectional view of the multiple channels shown in FIG. 2,

### DETAILED DESCRIPTION

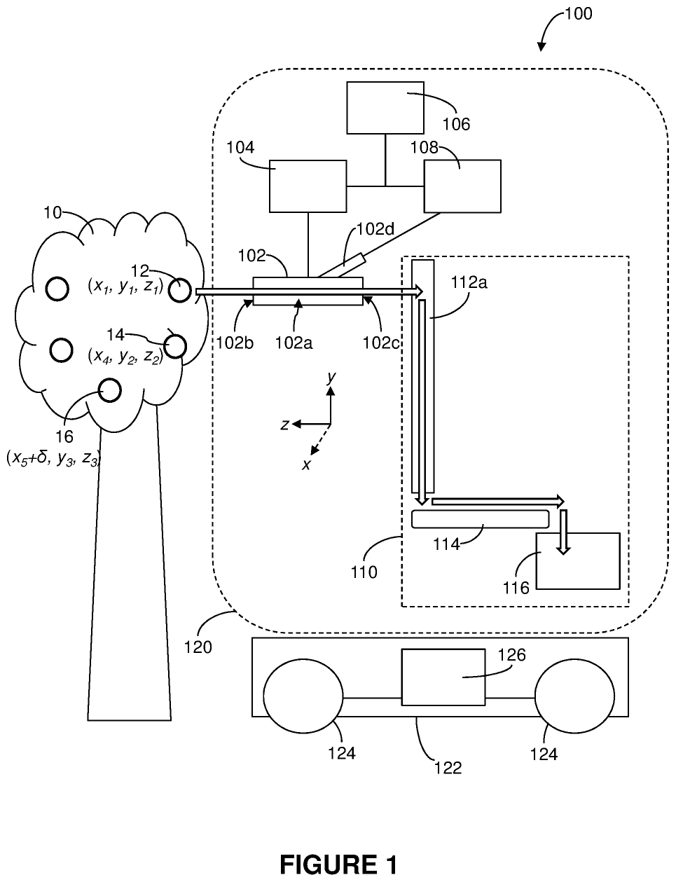

FIG. 1 illustrates a diagram of an example robotic system 100 for harvesting fruit. The robotic system 100 includes an end effector 102 that is operated to pick fruit (e.g., one or more of fruit 12, 14, and 16) from a tree 10. The end effector 102 is coupled to a positioning system 104 that can control the motion and positioning of the end effector 102. As shown in FIG. 1, within a three-dimensional space defined by the x-, y-, and z-axes, the fruit 12 is positioned at coordinates (x₁, y₁, z₁), the fruit 14 is positioned at coordinates (x⁴, y₂, z₂), and the fruit 16 is positioned at coordinates (x₅+δ, y₃, z₃). The positioning system 104 can move the end effector 102 horizontally along the x-axis, vertically along the y-axis, and toward the tree 10 along the z-axis to pick a particular fruit. For example, the positioning system 104 can move the end effector 102 to reach the coordinates (x₁, y₁, z₁) and pick the fruit 12.

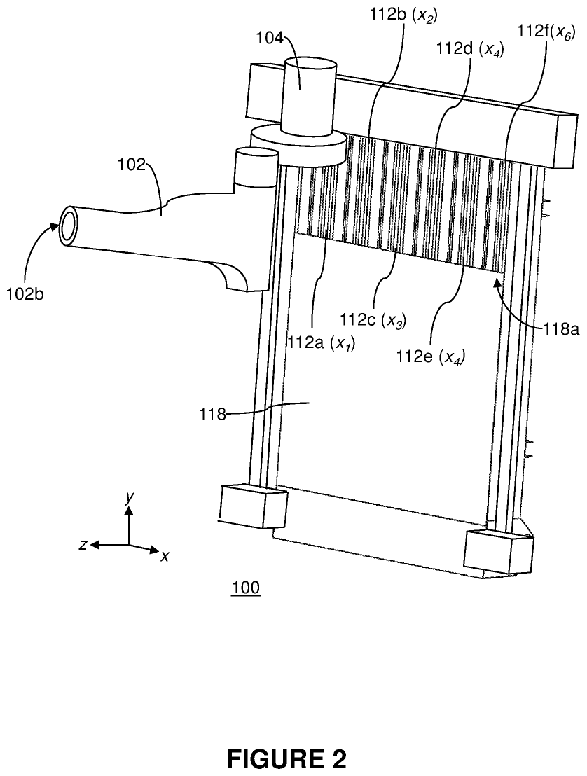

The positioning system 104 may employ one or more actuation mechanisms to generate motion that is translated into movement of the end effector 102. The actuation mechanisms may be powered, for instance, by one or more batteries, generators, engines, or the like. Motion generated by the actuation mechanisms can be transmitted to the end effector 102 through any combination of arms, linkages, joints, tracks, gears, belts, chains, and/or other transmission components. As shown in the example of FIG. 2, for instance, the positioning system 104 may employ an arrangement of belts and gears to move the end effector 102.

The robotic system 100 also includes a controller 106 that is communicatively coupled to the positioning system 104. The controller 106 controls how the positioning system 104 moves the end effector 102. The controller 106 may include any type of processors, microprocessors, computing devices, and data storage devices (memories, transitory and non-transitory computer readable media, etc.). To control the positioning system 104, the controller 106 may process information from various sensors (e.g., vision sensors, speed sensors, proximity sensors, LIDAR devices, etc.) coupled to components of the robotic system 100. For instance, a vision sensor may be coupled to the end effector 102. to provide digital images of the tree 10 to the controller 106. The controller 106 can detect fruits in the images. In particular, the controller 106 may use image recognition techniques to identify groups of pixels in the image that represent fruits. The controller 106 can additionally determine three-dimensional coordinates (x, y, z) for the locations of the detected fruits. Based on these three-dimensional coordinates, the controller 106 can generate a plan that sets the sequence in which the detected fruits should be picked from the tree 10. The controller 106 can then signal the positioning system 104 to move the end effector 102 according to the plan. The controller 106 may also process the images to determine locations of obstacles to be avoided while moving the end effector 102. In addition to using information received from vision sensors, the controller 106 can use information from other sensors, such as proximity sensors, to achieve precise positioning and measured movement of the end effector 102.

As also shown in FIG. 1, the end effector 102 includes a conduit 102a that extends between a distal end and a proximal end. The conduit 102a includes an input port 102b disposed at the distal end and an output port 102c disposed at the proximal end. Additionally, the robotic system 100 includes a vacuum system 108 that is coupled to the end effector 102 via a connector 102d. The vacuum system 108 is configured to provide the end effector 102 with suction that allows fruits to be picked from the tree 10. In particular, a given fruit can be sucked from the tree 10 and into the conduit 102a via the input port 102b. In some cases, the positioning system 104 moves the end effector 102 within approximately 1 cm to 5 cm away from the fruit to allow the suction to apply sufficient force to separate the fruit from the tree 10.

The controller 106 is also communicatively coupled to the vacuum system 108 and can signal the vacuum system 108 to provide suction once the positioning system 104 moves the end effector 102 sufficiently near a fruit. The controller 106 can precisely coordinate the use of suction to pick fruit from the tree 10 with the planned movement of the end effector 102. The controller 106 may also receive information from various sensors, such as vacuum pressure sensors, to control how the suction is generated.

Additionally, the robotic system 100 includes a collection system 110 for receiving and storing the picked fruits. The positioning system 104 generally moves the end effector 102 relative to the collection system 110. In particular, as shown in FIG. 1. the positioning system 104 extends the end effector 102 in the positive z-direction away from the collection system 110 to pick a fruit 12 from the tree 10.

Once the end effector 102 picks the fruit from the tree 10, the positioning system 104 moves the end effector 102 back from the tree 10 and toward the collection system 110. In addition to picking a fruit from the tree 10 and drawing the fruit into the conduit 102a, the suction from the vacuum system 108 can provide the picked fruit with sufficient momentum to move the picked fruit through the conduit 102a. Thus, when the end effector 102 reaches the collection system 110, the fruit can be dispensed through the output port 102c and into the collection system 110. In some cases, the controller 106 may control the end effector 102 so that the picked fruit is dispensed through the output port 102c at the appropriate time to be received by the collection system 110.

As FIG. 1 illustrates, the collection system 110 includes a channel 112a (as described below, the collection system 110 includes multiple channels), a conveyor belt 114, and one or more receptacles 116. In an example scenario, the end effector 102 picks the fruit 12 and dispenses the fruit 12 into the channel 112a. As described further below, the channel 112a includes an elongate opening that allows the fruit 12 to pass into the channel 112a. The channel 112a extends downwardly along the y-axis from the end effector 102 to the conveyor belt 114. Once the fruit 12 is received into the channel 112a, the channel 112a guides the fruit 12 to the conveyor mechanism 114 as the fruit 12 moves downwardly under gravitational force. The conveyor belt 114 in turn receives the fruit 12 and conveys the fruit 12 to one of the receptacles 116, where the fruit 12 can be collected and stored.

As also shown in FIG. 1, components of the robotic system 100 may be combined in an assembly 120 on a mobile platform 122. The mobile platform 122 includes wheels 124 that are driven by an engine 126. In some cases, the engine 126 may also be employed to deliver power to the positioning system 104, the controller 106, the vacuum system 108, and/or other components of the robotic system 100. The mobile platform 122 can be driven and steered to position the assembly 120 near the tree 10 where the end effector 102 can reach the tree's fruits with operation of the positioning system 104. In alternative embodiments, the mobile platform 122 does not include an engine 126, but can be towed by another mechanism.

As described above, once the end effector 102 picks the fruit 12 from the tree 10, the positioning system 104 moves the end effector 102 toward the channel 112a. To move the end effector 102 toward the channel 112a, the positioning system 104 moves the end effector 102 in the negative z-direction, i.e., away from the tree 10. However, in an example implementation, the positioning system 104 does not move the end effector 102 along the y-axis to reach the channel 112a because the length of the channel 112a accommodates the range of vertical motion of the end effector 102 along the y-axis. In this way, the end effector 102 can dispense the fruit 12 into the channel 112a without being moved upwardly or downwardly by the positioning system 104.

FIG. 2 shows that the channel 112a is one of multiple channels 112a-f positioned in series along the x-axis. As FIG. 2 illustrates, each of the channels 112a-f extends vertically along the y-axis in a similar manner but is positioned at a different horizontal location along the x-axis. In this example, a center line of the channel 112a is positioned at coordinate x=x₁, a center line of the channel 112b is positioned at coordinate x=x₂, a center line of the channel 112c is positioned at coordinate x=x₃, a center line of the channel 112d is positioned at coordinate x=x₄, a center line of the channel 112e is positioned at coordinate x=x₅, and a center line of the channel 112f is positioned at coordinate x=x₆. Although the multiple channels 112a-f shown in FIG. 2 appear as an array of straight parallel channels, the multiple channels in other embodiments may have other shapes and/or configurations. For instance, the multiple channels may be curved to direct the fruits to desired locations. Additionally, although the examples herein may employ six channels, other embodiments may include a greater or fewer number of channels.

Because the fruit 12 is positioned on the tree 10 at coordinates (x₁, y₁, z₁) in the example scenario above, the channel 112a shares the same x-position as the end effector 102 when it picks the fruit 12, i.e., x=x₁. And as discussed above, the vertical length of the channel 112a allows the channel 112a to receive the fruit 12 at coordinate y=y₁ where it is picked by the end effector 102. Thus, after the end effector 102 picks the fruit 12, the positioning system 104 can dispense the fruit 12 into the collection system 110 simply by moving the end effector 102 in the negative z-direction toward to the channel 112a, with little or no movement along the x-axis or the y-axis. Advantageously, the end effector 102 can dispense the fruit 12 into the collection system 110 more quickly after picking the fruit 12, because the end effector 102 makes little or no movement along the x-axis or the y-axis. As a result, the robotic system 100 can then proceed to pick the next fruit more quickly.

When the robotic system 100 picks the fruit 14 positioned at coordinates (x₄, y₂, z₂) as shown in FIG. 1, the end effector 102 is positioned at coordinates (x₄, y₂) when the fruit 14 is picked. In this case, the channel 112d (instead of the channel 112a) shares the same x-position as the end effector 102, i.e., x=x₄, so the positioning system 104 can dispense the fruit 14 into the collection system 110 simply by moving the end effector 102 in the negative z-direction toward to the channel 112d, again with little or no movement along the x-axis or the y-axis.

In some cases, the end effector 102 may not be sufficiently aligned with one of the channels 112a-f when the end effector 102 picks a fruit. For instance, the end effector 102 may pick the fruit 16 positioned at coordinates (x₅+δ, y₃, z₃) as shown in FIG. 1. The end effector 102 is thus positioned at coordinates (x₅+δ, y₃) when the fruit 14 is picked. The offset δ along the x-axis might not allow the end effector 102 to move simply in the negative z-direction to dispense the fruit 16 into one of the channels 112a-f as described above with the fruits 12, 14. The controller 106, however, may determine that the channel 112e positioned at coordinate x=x₅ is the closet channel to the end effector 102 along the x-axis. Thus, the controller 106 can signal the positioning system 104 to move a distance of approximately in the negative x-direction to align the end effector 102 sufficiently with the channel 112e and allow the fruit 16 to be dispensed in the channel 112e. Although the end effector 102 in such cases may have to move along the x-axis as well as the z-axis when dispensing the fruit into the collection system 110, the presence of multiple channels 112a-f enables the controller 106 to find a nearby channel that limits the movement along the x-axis to a small adjustment.

In general, reducing the time between picking fruits and dispensing them in the collection system 110 enhances the efficiency of the picking process for the robotic system 100. This approach allows more fruit to be picked over a given period of time. In operation, the end effector 102 can repeatedly and rapidly extend away from the collection system 110 to suction a fruit into the conduit 102a and move back to the collection system 110 to dispense the fruit accurately into the closest channel.

As shown in FIG. 2, the multiple channels 112a-f angle in the positive z-direction as the multiple channels 112a-f extend downwardly from the end effector 102. As such, the multiple channels 112a-f provide an angled surface that guides the fruits as they move downwardly under gravitational force through the multiple channels 112a-f. Contact with the angled surface may also help to control the speed of the fruits as they move downwardly, which may prevent damage to the fruits when the fruits reach the bottom of the multiple channels 112a-f.

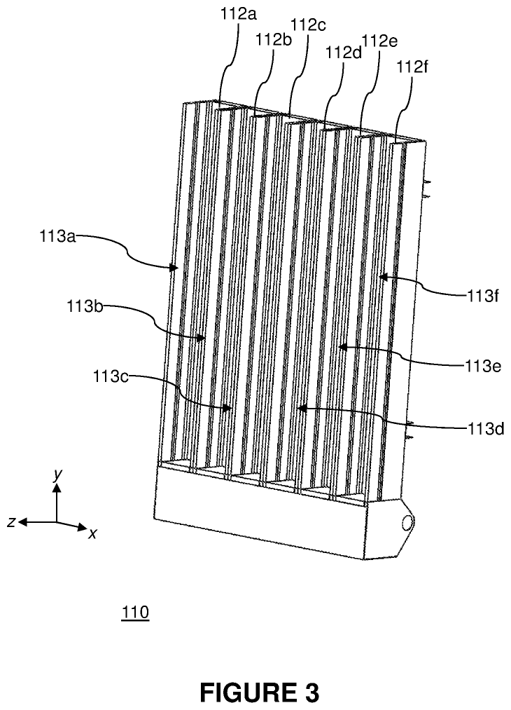

FIG. 3 provides another view of the multiple channels 112a-f of the collection system 110. As shown in FIG. 3, the multiple channels 112a-f include respective elongate openings 113a-f that extend vertically along the length of the multiple channels 112a-f in the y-direction. Fruits pass through the elongate openings 113a-f when the end effector 102 dispenses the fruits into the multiple channels 112a-f. To keep the fruits in the multiple channels 112a-f as they move downwardly, the collection system 110 may include a screen 118 or other panel disposed over the elongate openings 113a-f as shown in FIG. 2.

To allow the end effector 102 to dispense fruits into the multiple channels 112a-f, however, an upper edge 118a of the screen 118 is positioned below the output port 102c of the end effector 102 (i.e., at a lower position along the y-axis), so that the screen 118 does not block dispensed fruit from passing into the multiple channels 112a-f. Advantageously, the screen 118 is configured to move in response to movement of the end. effector 102 along the y-axis, so that the elongate openings 113a-f are covered by the screen 118 only at positions below the output port 102c of the end effector 102. In one embodiment, the screen 118 (e.g., the upper edge 218a) may be mechanically coupled to the positioning system 104, so that when the positioning system 104 moves the end effector 102 along the y-axis, the screen 118 moves correspondingly with the end effector 102. For instance, if the end effector 102 is moved to a lower y-position, the upper edge 118a. also moves to a lower y-position to remain below the output port 102c of the end effector 102. In example embodiments, the screen 118 may be coupled to a component of the positioning system 104 that directly moves with the end effector 102. In some cases, the screen 118 can retract into a roll by action of a spring as the upper edge 118a is lowered, and the screen 118 may unroll as the upper edge 118a is raised.

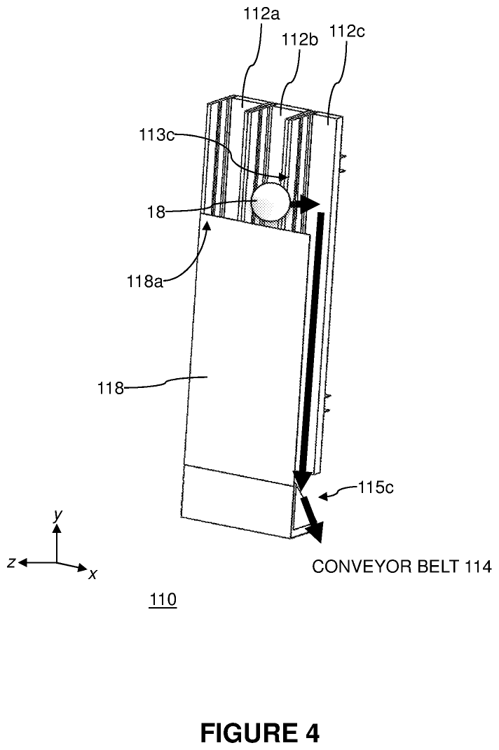

FIG. 4 provides a sectional view of the collection system 110 including the multiple channels 112a-f and the screen 118. As shown in FIG. 4, when the end effector 102 dispenses a fruit 18 into the closest channel 112c, the fruit 18 passes over the upper edge 118a of the screen 118, through the elongate opening 113c, and into the channel 112c. The fruit 118 then travels downwardly through the channel 112c where it passes through an opening 115c and to the conveyor belt 114 at the bottom of the channel 112c. As described above, the conveyor belt 114 operates between the multiple channels 112a-f and the receptacle 116 and conveys the fruit 18 from the channel 112c to the receptacle 116.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures, In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

What is claimed is:

1. A harvesting system comprising:
an end effector including a conduit extending between an input port and an output port;
a vacuum system coupled to the end effector and configured to provide the end effector with suction that allows an object to be sucked through the input port and into the conduit, the suction further causing the object to move through the conduit toward the output port;
a collection system including multiple channels extending along a vertical axis, the multiple channels being positioned in series along a horizontal axis; and
a positioning system coupled to the end effector and configured to move the end effector relative to the collection system,
wherein the positioning system is configured to move the end effector along the horizontal axis and/or the vertical axis and to extend the end effector away from the collection system and position the input port near the object to allow the suction from the vacuum system to suck the object through the input port and into the conduit, and
responsive to the object being sucked into the conduit, the positioning system is further configured to move the end effector toward the collection system and to position the output port at a selected channel of the multiple channels to allow the object to be dispensed from the output port into the selected channel, the selected channel being closest to the end effector along the horizontal axis from among the multiple channels.

2. The harvesting system of claim 1, wherein the collection system includes a conveyor belt and a receptacle,
the conveyor belt operates between the multiple channels and the receptacle, and
the multiple channels extend to the conveyor belt and include respective openings at the conveyor belt, such that:
after the selected channel receives the object, the object moves downwardly by gravitational force through the selected channel and onto the conveyor belt, and the conveyor belt conveys the object from the one channel to the receptacle.

3. The harvesting system of claim 1, wherein the positioning system moves the end effector toward the selected channel without moving the end effector along the vertical axis.

4. The harvesting system of claim 1, wherein the positioning system moves the end effector toward the selected channel without moving the end effector along the horizontal axis.

5. The harvesting system of claim 1, further comprising a controller coupled to the positioning system, wherein the controller determines a location of the object and controls the positioning system to move the end effector to the location.

6. The harvesting system of claim 5, wherein the controller controls the positioning system to adjust a position of the end effector along the horizontal axis to align the output port with the selected channel.

7. The harvesting system of claim 5, wherein the controller controls the vacuum system to coordinate the suction provided by the vacuum system with movement of the end effector via the positioning system.

8. The harvesting system of claim 1, wherein an elongate opening extends vertically along each of the multiple channels, and the selected channel receives the object through the respective elongate opening of the one channel.

9. The harvesting system of claim 8, wherein after the selected channel receives the object, the object moves downwardly under gravitational force through the one channel below the end effector, and the collection system includes a screen disposed over the elongate openings of the multiple channels, the screen configured to move in response to movement of the end effector along the vertical axis such that the screen covers the elongate openings below the end effector.

10. The harvesting system of claim 9, wherein the screen is mechanically coupled to the positioning system such that when the positioning system moves the end effector along the vertical axis, the screen moves correspondingly to remain below the end effector.

11. The harvesting system of claim 1, wherein after the selected channel receives the object, the object moves downwardly under gravitational force through the selected channel below the end effector, and the selected channel provides an angled surface that guides the object as the object moves downwardly.
